(19) United States
(12) Patent Application Publication
(10) Pub. No.: US 2001/0030623 A1
(43) Pub. Date: Oct. 18, 2001

(54) Position search system

(75) Inventors: Gunji Shimada, Osaka (JP); Hirofumi Uchida, Osaka (JP); Junichi Kataoka, Osaka (JP)

Correspondence Address: REED SMITH HAZEL THOMAS LLP, Suite 1400, 3110 Fairview Park Drive, Falls Church, VA, 22042, US

(73) Assignee: Hirofumi UCHIDA

(21) Appl. No.: 09/836,340

(22) Filed: Apr. 18, 2001

Related U.S. Application Data
(63) Continuation of application No. 09/157,390, filed on Sep. 21, 1998, now abandoned.

(51) Int. Cl. G01S 5/14

(52) U.S. Cl. 342/357.07; 342/357.1; 701/208

(57) ABSTRACT

A position search system incorporates a personal handy terminal having a telephone number and/or an ID number to be accessed by a third person. The system includes a device for receiving GPS signals to provide position information and means for transmitting the position information through radio-frequency circuit, a mobile communication station having a mechanism for receiving the position information through the radio-frequency circuit and a device for transmitting the position information through a general cable circuit, a host server having a device for receiving and transmitting the position information through the general cable circuit, and a personal computer connected to the host server through the general cable circuit to supervise behavior of a user of the personal handy terminal. The personal handy terminal further includes a port for accepting image data, using a video device, digital camera, etc.

### FIELD OF THE INVENTION

The present invention relates to a position search system using a terminal having position information obtained by global positioning satellite (“GPS”) signals, and especially relates to a position search system which can transmit, from a terminal having position information obtained by GPS signals through a server (host computer) to a third person, the position information together with other information.

### DESCRIPTION OF THE PRIOR ART

As a device which uses position information by the use of GPS, a car navigator is well known. That is, by using radio waves from a plurality of satellites, a navigator mounted on an automobile detects its position, and the driver runs the automobile toward the destination according to a map provided in the navigator.

However, in the navigator, merely one's own destination is recognized on the map by one's own accord, though the position information is detected by the use of GPS at all times, and it has no function to transmit various types of data such as the position information, the running condition of the automobile, or the destination to a third person.

Furthermore, a portable telephone system using a radio-frequency circuit, a cable circuit, and a switchboard is also put to practical use. In such a portable telephone system, the speaking persons concerned can mutually ascertain their own positions, but the portable telephone system has no function for a third person to ascertain the positions of the persons concerned.

### SUMMARY OF THE INVENTION

Therefore, an object of the present invention is to provide a novel position search system which can transmit, from a terminal having position information obtained by GPS signals to a third person, the position information.

Another object of the present invention is to provide a position search system which can transmit, from a terminal having position information obtained by GPS signals through a server (host computer) to a third person, the position information together with other information.

A further object of the present invention is to provide a position search system which can be applied to various types of applications by transmitting, from a terminal having position information obtained by GPS signals to a third person, the position information.

A still further object of the present invention is to provide a personal handy terminal having position information obtained by GPS signals.

These objects of the present invention are achieved by the following arrangements:

According to one aspect of the present invention, there is provided a position search system which comprises a personal handy terminal having a telephone number and/or an ID number to be accessed by a third person, and further include means for transmitting the position information through radio-frequency circuit, a mobile communication station having means for receiving the position information through the radio frequency circuit and means for transmitting the position information through a first general cable circuit, a host server having means for receiving and transmitting the position information through a second general cable circuit, and a personal computer connected to the host server through the second general cable circuit to supervise behavior of a user of the personal handy terminal.

### BRIEF DESCRIPTION OF THE DRAWINGS

The novel and distinctive features of the invention are set forth in the claims appended to the present application. The invention itself, however, together with further objects and advantages thereof may best be understood by reference to the following description and accompanying drawings in which:

FIG. 1 is a block diagram showing a position search system according to an embodiment of the present invention; and

FIG. 2 is a block diagram showing a personal handy terminal according to the embodiment of the present invention.

### DESCRIPTION OF THE PREFERRED EMBODIMENT

An embodiment according to the present invention will be described by referring to the drawings.

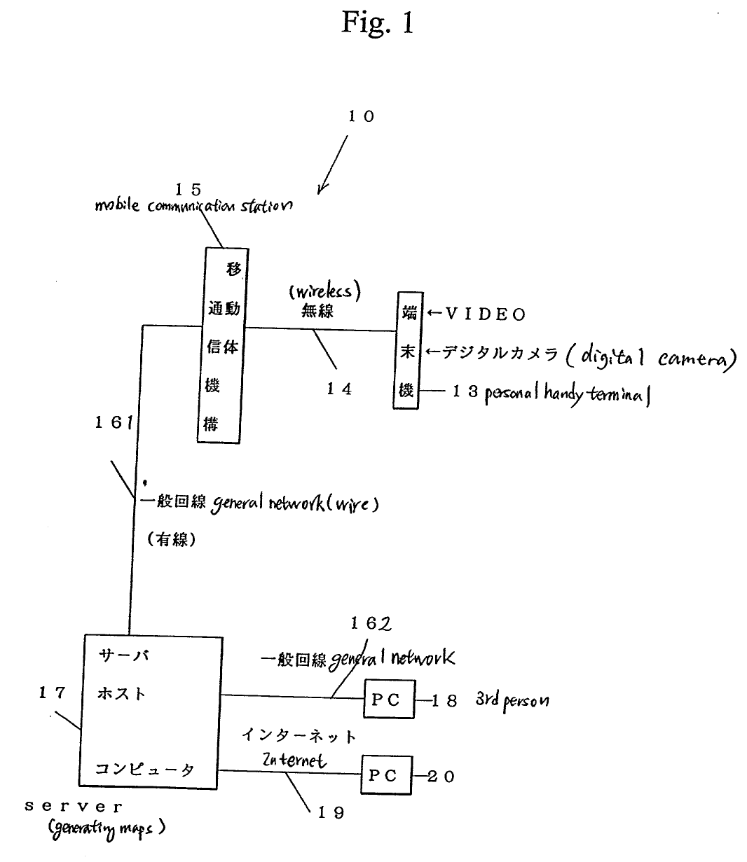

FIG. 1 shows a position search system 10 using GPS signals, which includes a personal handy terminal 13, such as portable telephones, provided with an antenna 12 for receiving GPS signals from GPS satellites at all times and having a telephone number and/or an ID number. The terminal 13 has a function to take in image data from a video device, a digital camera, or the like, and further, it is arranged to be accessed by a third person or a user by the telephone number and/or ID number, and is also arranged to transmit the position information which changes with the time or the travel of the terminal 13 and the image data, to the third person by the GPS signals. The terminal 13 is connected to a mobile communication station (company) 15 through a radio-frequency circuit 14, and the mobile communication station 15 is connected to a host server (host computer) 17 through a first general cable circuit 161. The server 17 is connected to a PC (personal computer) 18 operated by the third person, through a second general cable circuit 162, or it is connected to a similar PC (personal computer) 20 through the Internet 19.

The operation of the position search system 10 will be described. When accessing the specified personal handy terminal 13, the third person operates the PC 18 to transmit the telephone number and/or ID number through the server 17 and the mobile communication station 15 to the terminal 13. The position information changing with time is transmitted from the accessed terminal 13 through the circuits 14 and 161 to the server 17. The server 17 includes road map data base, and also has the function of making a map on the basis of the received position information, and the generated map is transmitted to the PC 18. The third person can ascertain the position of the terminal 13, that is, the position of elapse of time of the person having the terminal 13, the distance of running, the present position, and the like, by watching the map transmitted to the PC 18.

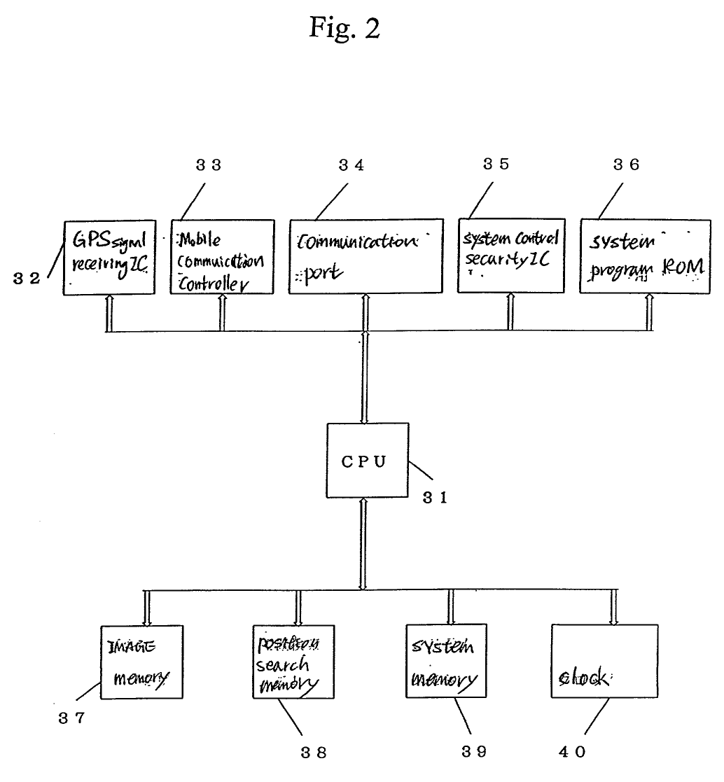

FIG. 2 illustrates a block circuit 30 showing the arrangement of the personal handy terminal 13. The block circuit 30 includes a CPU 31 to which are connected a GPS signal receiving IC (Integrated Circuit) 32 for detecting the position information of latitude and longitude on the basis of GPS signals from the GPS satellite 11, a mobile communication controller 33 for transmitting and receiving radio-frequency signals for the mobile communication station 15, a communication port 34 for performing the maintenance of external devices such as the PC 18 and 20, a system control security IC 35 for preventing outside interference, the abuse of the system, or the like, a system program ROM 36, an image memory 37 for storing image data from a video device, a digital camera, a CCD camera or the like, a position search memory 38 for storing data from the GPS signal receiving IC 32, a system memory 39 having stack and work areas and to be used by the system, and a time watching real time clock 40, thereby providing the personal handy terminal 13.

As mentioned above, according to the present invention, the personal handy terminal to be accessed by the telephone number and/or ID number stores position information received at all times by the GPS signals, and also has the function of transmitting the position information, so that it can be applied to a material circulation or distribution system, an operating system of vehicles such as taxicabs or trucks, a burglary prevention system for vehicles or the like, a detection system for the aged, and the like, by combining the personal handy terminal together with a server, with a conventional cable circuit and a conventional radio-frequency circuit.

While the invention has been particularly shown and described with reference to preferred embodiments thereof, it will be understood by those skilled in the art that the foregoing and other changes in form and detail can be made therein without departing from the spirit and scope of the invention.

What is claimed is:

1. A position search system comprising:
a personal handy terminal having a telephone number and/or an ID number to be accessed by a third person, said personal handy terminal including means for receiving GPS signals to provide position information and means for transmitting said position, information through a radio-frequency circuit;
a mobile communication station having means for receiving said position information through said radio-frequency circuit and means for transmitting said position information through a general cable circuit;
a host server having means for receiving and transmitting said position information through said general cable circuit; and
a personal computer connected to said host server through said general cable circuit to supervise behavior of a user of said personal handy terminal.

2. The position search system according to claim 1 wherein said personal handy terminal includes means for accepting image data supplied from an external device.

3. The position search system according to claim 1 wherein said personal handy terminal includes at least a position search memory and image memory connected to a CPU.

4. The position search system according to claim 1 wherein said host server includes road map data base to provide a map depending on the received position information.
